(19) United States
(12) Patent Application Publication
(10) Pub. No.: US 2011/0303009 A1
(43) Pub. Date: Dec. 15, 2011

(54) TRI-AXIS ACCELEROMETER

(76) Inventors: Bin Yang, Shenzhen (CN); Zhen-kui Meng, Shenzhen (CN); Rui Zhang, Shenzhen (CN); Zhou Ge, Shenzhen (CN); Yi-lin Yan, Shenzhen (CN)

(21) Appl. No.: 13/015,927

(22) Filed: Jan. 28, 2011

(30) Foreign Application Priority Data
Jun. 11, 2010 (CN) 201010198641.4

(51) Int. Cl. G01P 15/125

(52) U.S. Cl. 73/514.32

(57) ABSTRACT

An tri-axis accelerometer is disclosed. The tri-axis accelerometer includes a mass, a first group of capacitance, a third group of capacitance being neighbor to the first group of capacitance. The mass defines an upper surface, a lower surface parallel to the upper surface and a side wall connecting the upper surface and the lower surface. The first group of capacitance includes a first movable electrode and the third group of capacitance includes a third movable electrode. The first movable electrode is perpendicular to the third movable electrode.

### BACKGROUND OF THE INVENTION

1. Field of the Invention

The present invention generally relates to the arts of sensors and more particularly, to a tri-axis accelerometer for measuring accelerations in three orthogonal axial directions perpendicular to each other.

2. Description of Related Art

Generally, sensors for measuring force can be classified into accelerometers and gyroscopes. The tri-axis accelerometers are used in a field of automobiles widely, for example, a braking system in an automobile. In recent years, the applied fields of the tri-axis accelerometers are increasing rapidly because of its low cost. The tri-axis accelerometers are being used in electronic products such as mobile telephones, computers and digital camera gradually. But the structure of a related tri-axis accelerometer makes it difficult to make a miniature tri-axis accelerometer. And the sensitivity of the related tri-axis accelerometer is relatively low.

So, it is necessary to provide a new tri-axis accelerometer to solve the problems mentioned above.

### 3. BRIEF DESCRIPTION OF THE DRAWINGS

FIG. 1 is an isometric view of a tri-axis accelerometer in accordance with a first embodiment of the present invention;

FIG. 2 is an isometric view of a tri-axis accelerometer in accordance with a second embodiment of the present invention;

FIG. 3 is a top view of the tri-axis accelerometer in FIG. 2;

FIG. 4 is a cross-sectional view of the tri-axis accelerometer along a line A-A′ in FIG. 2; and

FIG. 5 is a cross-sectional view of the tri-axis accelerometer along a line B-B′ in FIG. 2.

### 4. DETAILED DESCRIPTION OF EXEMPLARY EMBODIMENTS

Reference will now be made to describe the exemplary embodiments of the present invention in detail.

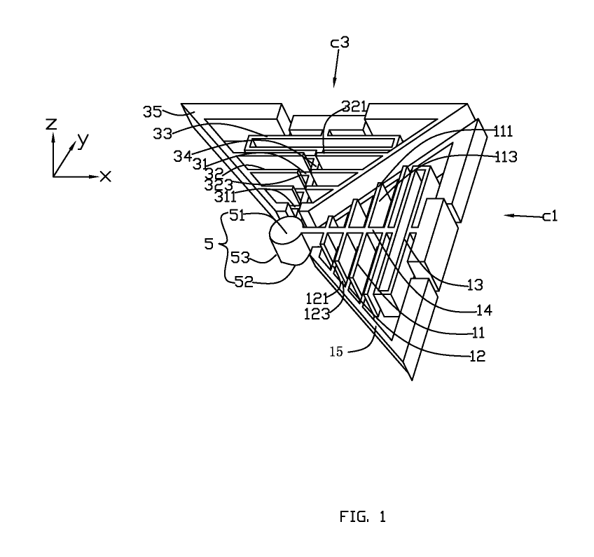

Referring to FIG. 1, a tri-axis accelerometer comprises a substrate (not shown), a mass 5, a first group of capacitance c1, a third group of capacitance c3 neighbor to the first group of capacitance c1.

The mass 5 can move relative to the substrate. The mass defines an upper surface 51, a lower surface 52 parallel to the upper surface 51 and a side wall 53 connecting the upper surface 51 and the lower surface 52.

The first group of capacitance c1 comprises a first movable electrode axis 14 connecting to the side wall 53, a first spring supporting member 13 connecting the first movable electrode axis 14 to the substrate, a plurality of first movable electrodes 11 perpendicularly extending from the first movable electrode axis 14, a plurality of first fixing electrodes 12 parallel to the first movable electrodes 11 and being rooting on the substrate.

At least one first movable electrode 11 is located between two adjacent first fixing electrodes 12, and at least one first fixing electrode 12 is located between two adjacent first movable electrodes 11. There is an overlapping area brought by the first movable electrode 11 and the first fixing electrode 12 next to the said first movable electrode 11.

The first movable electrode 11 defines a first top surface 111 and a first lower surface (not labeled) both parallel to the upper surface 51, a first side wall 113 connecting the first top surface 111 and the first lower surface. The first fixing electrode 12 defines a second top surface 121 and a second lower surface (not labeled) both being parallel to the upper surface 51, a second side wall 123 connecting the second top surface and the second lower surface. The first top surface 111 is closer to the upper surface 51 than the second top surface 121, and the first lower surface is closer to the upper surface 51 than the second lower surface.

The third group of capacitance c3 comprises a third movable electrode axis 34 connecting to the side wall 53, a third spring supporting member 33 connecting the third movable electrode axis 34 to the substrate, a plurality of third movable electrodes 31 perpendicularly extending from the third movable electrode axis 34, a plurality of third fixing electrodes 32 being parallel to the third movable electrodes 31 and being rooting on the substrate.

At least one third movable electrode 31 is located between two adjacent third fixing electrodes 32, and at least one third fixing electrode 32 is located between two adjacent third movable electrodes 31. There is an overlapping area brought by the third movable electrode 31 and the third fixing electrode 32.

The third movable electrode 31 defines a third top surface 311 and a third lower surface (not labeled) both parallel to the upper surface 51, a third side wall 113 connecting the third top surface and the third lower surface. The third fixing electrode 32 defines a second top surface 321 and a second lower surface both parallel to the upper surface 51, a second side wall 323 connecting the second top surface and the second lower surface. The third top surface 311 is closer to the upper surface 51 than the second top surface 321 and the third lower surface is nearer to the upper surface 51 than the second lower surface.

The first movable electrodes 11 are perpendicular to the third movable electrodes 31.

The first group of capacitance c1 further comprises a first fixing electrode axis 15 for rooting the first fixing electrode 12 on the substrate. The first fixing electrode axis 15 is not connected to the mass 5. The first fixing electrodes 15 extend from the first fixing electrode axis 15 toward the first movable electrode axis 14. The third group of capacitance c3 further comprises a third fixing electrode axis 35 for rooting the third fixing electrode 32 on the substrate. The third fixing electrode axis 35 is not connected to the mass 5. The third fixing electrodes 35 extend from the third fixing electrode axis 35 toward the third movable electrode axes 34.

When the mass 5 moves along a positive direction of X axis, a distance between the first fixing electrode 12 and the adjacent first movable electrode 11 is reduced, which increases the capacitance value therebetween. Thus, the accelerometer outputs a signal indicating the movement of the mass 5. When the mass 5 moves along a negative direction of X axis, a distance between the first fixing electrode 12 and the adjacent first movable electrode 11 is increased, which reduces the capacitance value therebetween, Thus, the accelerometer outputs a signal indicating the movement of the mass. When the mass moves along the Y axis, the capacitance values between the third fixing electrodes and the adjacent movable electrodes are reduced or increased, which also outputs signals indicating the movement of the mass.

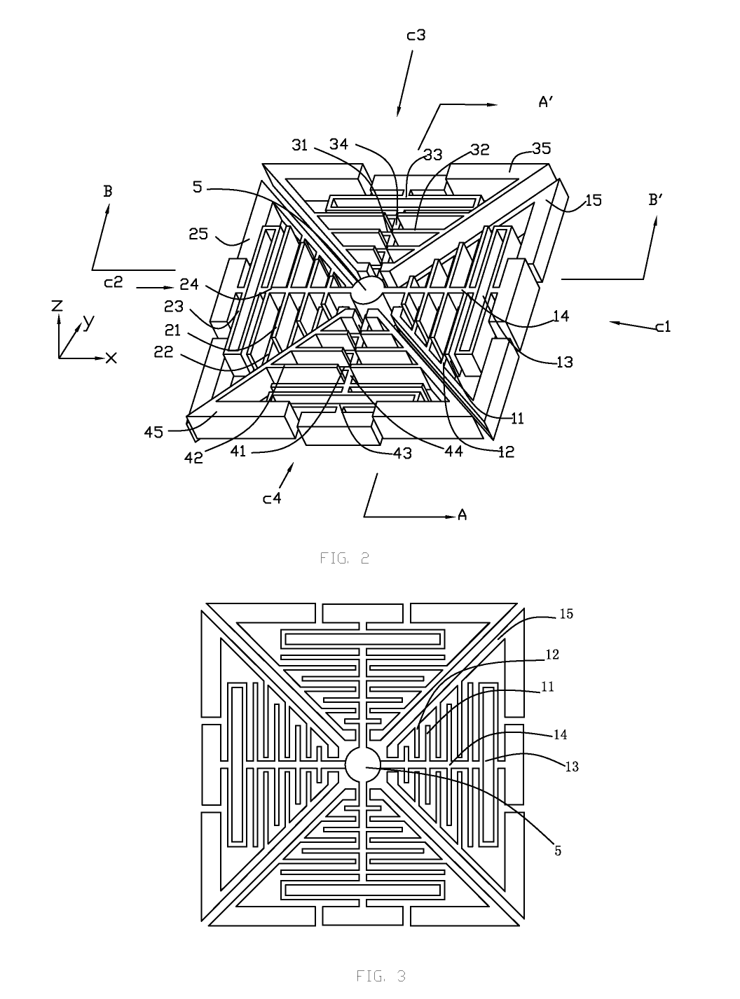

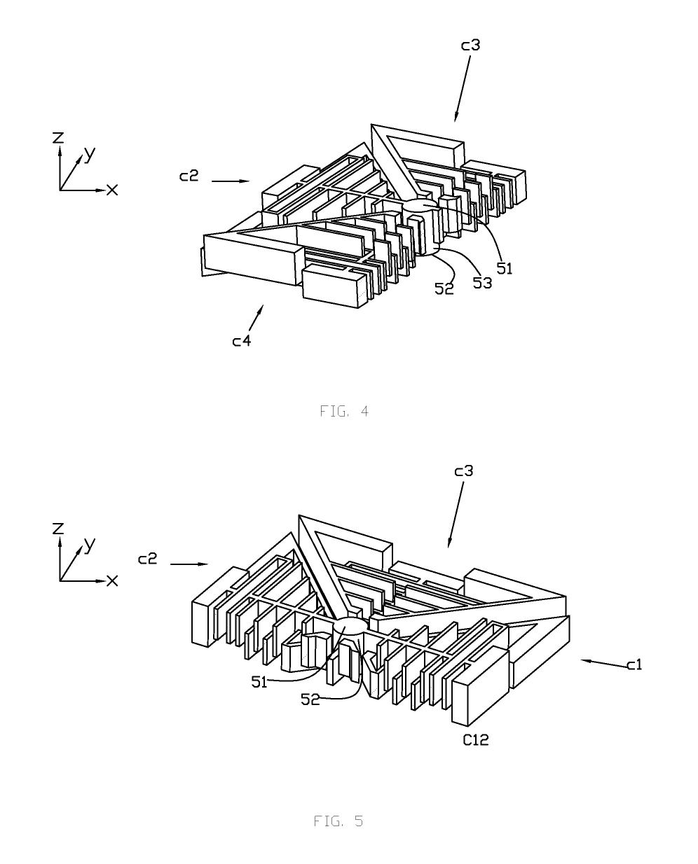

Referring to FIGS. 2-5, the tri-axis accelerometer further comprises a second group of capacitance c2 connecting to the mass 5 and a fourth group of capacitance c4 connecting to the mass 5. The second group of capacitance c2 has the same structure as the first group of capacitance c1. The second group of capacitance c2 is symmetrical with the first group of capacitance c1 about the mass 5. The fourth group of capacitance c4 has the same structure as the third group of capacitance c3 and the fourth group of capacitance c4 is symmetrical with the third group of capacitance c3 about the mass 5.

Referring to FIGS. 2-3, the tri-axis accelerometer comprises a mass 5 defining a top surface 51, a bottom surface 52 and a side wall 53 connecting the top surface 51 and the bottom surface 52, four groups of capacitances connecting to the mass 5 separately named c1, c2, c3,c4. Every capacitance comprises a movable electrode 11,21,31,41, a stationary electrode 12,22,32,42, a spring supporting member 13,23,33,43, a movable electrode axis 14,24,34,44, and a first stationary electrode axis 15,25,35,45. Every two adjacent movable electrodes define a first gap therebetween and every two adjacent stationary electrodes define a second gap therebetween. At least one stationary electrode locates in the first gap and at least one movable electrode locates in the second gap. The four groups of capacitances are distributed around the mass 5. And the first capacitance c1 is symmetrical with the second group capacitance c2 about the mass 5, and the third capacitance c3 is symmetrical with the fourth group capacitance c4 about the mass 5. All the movable electrodes 11,21,31,41 and the spring supporting members 13,23,33,43 are connected together by the mass 5.

For example, the first group of capacitance c1 comprises a first movable electrode 11, a first stationary electrode 12 and a first spring supporting member 13, a first movable electrode axis 14 and a first fixing electrode axis 15 for rooting the first stationary electrodes 12. The first movable electrode axis 14 defines a first end connected to the side wall 53, a second end connected to the first spring supporting member 13 and a side surface connecting the first and second ends. The first movable electrode 11 extends from the side surface. Every two adjacent first movable electrodes 11 define a first gap therebetween and every two adjacent first stationary electrodes 12 define a second gap therebetween. At least one first stationary electrode 12 locates in the first gap and at least one first movable electrode 11 locates in the second gap.

The first movable electrode 11 defines a first movable electrode top surface 111, a first movable electrode bottom surface and a first movable electrode side wall connecting the first movable electrode top surface 111 and the first movable electrode bottom surface. The first stationary electrode 12 defines a first stationary electrode top surface 121, a first stationary electrode bottom surface and a first stationary electrode side wall connecting the first stationary electrode top surface 121 and the first stationary electrode bottom surface.

The first movable electrode top surface 111 and the first stationary electrode top surface 121 are not co-planar to each other. The first movable electrode top surface 111 and the first stationary electrode bottom surface are not co-planar to each other. The first movable electrode bottom surface and the first stationary electrode bottom surface are not co-planar to each other. The first movable electrode bottom surface and the first stationary electrode top surface are not co-planar to each other.

The second group of capacitance c2 has the same structure as the first group of capacitance c1. The second group of capacitance c2 is distributed around the mass 5 and symmetrical with the first group capacitance c1 about the mass 5.

The third group of capacitance c3 comprises a third movable electrode 31, a third stationary electrode 32 and a third spring supporting member 33, a third movable electrode axis 34 and a third fixing electrode axes 35 for rooting the third stationary electrodes 32. The third movable electrode axes 34 defines a third end connected to the side wall 53, a fourth end connected to the third spring supporting member 33 and a side surface connecting the third end and the fourth end. The third movable electrode 31 extends from the side surface. Every two adjacent third movable electrodes 31 define a first gap therebetween and every two adjacent third stationary electrodes 32 define a second gap therebetween. At least one third stationary electrode 32 locates in the first gap and at least one third movable electrode 31 locates in the second gap.

The third movable electrode 31 defines a third movable electrode top surface 311, a third movable electrode bottom surface and a third movable electrode side wall connecting the third movable electrode top surface 311 and the third movable electrode bottom surface. The third stationary electrode 32 defines a third stationary electrode top surface 321, a third stationary electrode bottom surface and a third stationary electrode side wall connecting the third stationary electrode top surface 321 and the third stationary electrode bottom surface.

The third movable electrode top surface 311 and the third stationary electrode top surface 321 are not co-planar to each other. The third movable electrode top surface 311 and the third stationary electrode bottom surface are not co-planar to each other. The third movable electrode bottom surface and the third stationary electrode bottom surface are not co-planar to each other. The third movable electrode bottom surface and the third stationary electrode top surface are not co-planar to each other.

The fourth group of capacitance c4 has the same structure as the third group of capacitance c3. The fourth group of capacitance c4 is distributed around the mass 5 and symmetrical with the third group capacitance c3 about the mass 5.

An angel formed by the first movable electrode axis 14 and the third movable electrode axis 34 is 90 degree. An angel formed by the second movable electrode axis 24 and the fourth movable electrode axis 44 is 90 degree.

When the mass 5 moves along a positive direction of X axis, a distance between the first stationary electrode 12 and the adjacent first movable electrode 11 is reduced, which increases the capacitance value therebetween. Thus, the accelerometer outputs a signal indicating the movement of the mass 5. When the mass 5 moves along a negative direction of X axis, a distance between the first fixing electrode 12 and the adjacent first movable electrode 11 is increased, which reduces the capacitance value therebetween. Thus, the accelerometer outputs a signal indicating the movement of the mass. When the mass moves along the Y axis, the capacitance values between the third stationary electrodes and the adjacent movable electrodes are reduced or increased, which outputs signals indicating the movement of the mass. When the mass moves along the Z axis, the capacitance values between the stationary electrodes and the adjacent movable electrodes are reduced or increased, which also outputs signals indicating the movement of the mass.

While the present invention has been described with reference to specific embodiments, the description of the invention is illustrative and is not to be construed as limiting the invention. Various of modifications to the present invention can be made to the exemplary embodiments by those skilled in the art without departing from the true spirit and scope of the invention as defined by the appended claims.

What is claimed is:

1. A tri-axis accelerometer comprising
a mass, a first group of capacitance, a third group of capacitance being neighbor to the first group of capacitance, the mass defining an upper surface, a lower surface being parallel to the upper surface and a side wall connecting the upper surface and the lower surface;
the first group of capacitance comprising
a first movable electrode axis connected to the side wall,
a first spring supporting member connecting the first movable electrode axis;
a plurality of first movable electrodes perpendicularly extending from the first movable electrode axis;
a plurality of first fixing electrodes being parallel to the first movable electrodes,
at least one first movable electrode located between two adjacent first fixing electrodes and at least one first fixing electrode located between two adjacent first movable electrodes;
the first movable electrode defining a first top surface and a first lower surface being parallel to the upper surface, a first side wall connecting the first top surface and the first lower surface;
the first fixing electrode defining a second top surface and a second lower surface being parallel to the upper surface, a second side wall connecting the second top surface and the second lower surface;
the first top surface being closer to the upper surface than the second top surface, and the first lower surface being closer to the upper surface than the second lower surface;
the third group of capacitance comprising:
a third movable electrode axis connected to the side wall,
a third spring supporting member connecting the third movable electrode axis and the substrate,
a plurality of third movable electrodes perpendicularly extending from the third movable electrode axis;
a plurality of third fixing electrodes being parallel to the third movable electrodes;
at least one third movable electrode located between two adjacent third fixing electrodes and at least one third fixing electrode located between two adjacent third movable electrodes;
the third movable electrode defining a third top surface and a third lower surface being parallel to the upper surface, a third side wall connecting the third top surface and the third lower surface;
the third fixing electrode defining a fourth top surface and a fourth lower surface being parallel to the upper surface, a fourth side wall connecting the fourth top surface and the fourth lower surface,
the third top surface being closer to the upper surface than the fourth top surface, and the third lower surface being closer to the upper surface than the fourth lower surface;
the first movable electrode being perpendicular to the third movable electrode.

2. A tri-axis accelerometer as described in claim 1, wherein
the first group of capacitance further comprises a first fixing electrode axis, and the first fixing electrode axis is disconnected to the mass, the first fixing electrode extends from the first fixing electrode axis toward the first movable electrode axis; and
the third group of capacitance further comprises a third fixing electrode axis, and the third fixing electrode axis is disconnected to the mass, the third fixing electrode extends from the third fixing electrode axis toward the third movable electrode axis.

3. A tri-axis accelerometer as described in claim 1, wherein
the tri-axis accelerometer further comprises a second group of capacitance connected to the mass and a fourth group of capacitance connected to the mass,
the second group of capacitance has the same structure as the first group of capacitance and the second group of capacitance is symmetrical with the first group of capacitance about the mass;
the fourth group of capacitance has the same structure as the third group of capacitance and the fourth group of capacitance is symmetrical with the third group of capacitance about the mass.

4. A tri-axis accelerometer comprising
a mass, a first group of capacitance and a third group of capacitance being neighbor to the first group of capacitance,
the mass defining a top surface, a bottom surface being parallel to the upper surface and a side wall connecting the top surface and the bottom surface;
the first group of capacitance comprising
a first spring supporting member,
a first movable electrode axis defining a first end connected to the side wall, a second end connected to the first spring supporting member and a side surface connecting the first end and the second end,
a plurality of first movable electrodes perpendicularly extending from the movable electrode axis and defining a first movable electrode top surface, a first movable electrode bottom surface and a first movable electrode side wall connecting the first movable electrode top surface and the first movable electrode bottom surface;
a plurality of first stationary electrodes being parallel to the first movable electrodes and defining a first stationary electrode top surface, a first stationary electrode bottom surface and a first stationary electrode side wall connecting the first stationary electrode top surface and the first stationary electrode bottom surface;
a first stationary electrode axis being disconnected to the mass, the first stationary electrodes extending from the first fixing electrode axis toward the first movable electrode axis;
every two adjacent first movable electrodes defining a first gap therebetween and every two adjacent first stationary electrodes defining a second gap therebetween,
at least one first stationary electrode located in the first gap and at least one first movable electrode located in the second gap;
the first movable electrode top surface and the first stationary electrode top surface being not co-planar to each other, the first movable electrode top surface and the first stationary electrode bottom surface being not co-planar to each other, the first movable electrode bottom surface and the first stationary electrode bottom surface being not co-planar to each other, the first movable electrode bottom surface and the first stationary electrode top surface being not co-planar to each other;
the third group of capacitance comprising
a third spring supporting member,
a third movable electrode axis defining a third end connected to the side wall, a fourth end connected to the third spring supporting member and a side surface connecting the third end and the fourth end,
a plurality of third movable electrodes perpendicularly extending from the third movable electrode axis and defining a third movable electrode top surface, a third movable electrode bottom surface and a third movable electrode side wall connecting the third movable electrode top surface and the third movable electrode bottom surface;
a plurality of third stationary electrodes being parallel to the third movable electrodes and defining a third stationary electrode top surface, a third stationary electrode bottom surface and a third stationary electrode side wall connecting the third stationary electrode top surface and the third stationary electrode bottom surface;
a third stationary electrode axis being disconnected to the mass, the third stationary electrodes extending from the third fixing electrode axis toward the third movable electrode axis;
every two adjacent third movable electrodes defining a third gap therebetween and every two adjacent third stationary electrodes defining a fourth gap therebetween,
at least one third stationary electrode located in the third gap and at least one third movable electrode located in the fourth gap;
the third movable electrode top surface and the third stationary electrode top surface being not co-planar to each other, the third movable electrode top surface and the third stationary electrode bottom surface being not co-planar to each other, the third movable electrode bottom surface and the third stationary electrode bottom surface being not co-planar to each other, the third movable electrode bottom surface and the third stationary electrode top surface being not co-planar to each other;
an angel forming by the first movable electrode axis and the third movable electrode axis being 90 degree.

5. A tri-axis accelerometer as described in claim 4, wherein the tri-axis accelerometer further comprises
a second group of capacitance connected to the mass and a fourth group of capacitance connected to the mass,
the second group of capacitance has the same structure as the first group of capacitance and the second group of capacitance is symmetrical with the first group of capacitance about the mass;
the fourth group of capacitance has the same structure as the third group of capacitance and the fourth group of capacitance is symmetrical with the third group of capacitance about the mass.
